(19) United States
(12) Patent Application Publication
(10) Pub. No.: US 2002/0015356 A1
(43) Pub. Date: Feb. 7, 2002

(54) Method for moistening or wetting bulk material

(76) Inventor: Hartmut Haverland, Bad Lippspringe (DE)

Correspondence Address: Dike, Bronstein, Roberts & Cushman, Intellectual Property Practice Group, EDWARDS & ANGELL, LLP, 130 Water Street, Boston, MA, 02109-4280, US

(21) Appl. No.: 09/834,313

(22) Filed: Apr. 13, 2001

(30) Foreign Application Priority Data
Apr. 14, 2000 (DE) 100 18 588.6

(51) Int. Cl. B01F 15/06

(52) U.S. Cl. 366/148

(57) ABSTRACT

Method for moistening or wetting bulk material The invention concerns a method for moistening or wetting bulk material. The fluids or pastes are thereby cooled down below their solidification point before being mixed with the bulk material to be wetted. During mixing or after mixing with the bulk material, moistening or wetting is carried out through re-liquidization of the solidified fluids or pastes. This method permits uniform and agglomerate-free moistening or wetting of bulk material.

This application claims Paris Convention priority of German patent application No. 100 18 588.6-23, filed Apr. 14, 2000, the complete disclosure of which is hereby incorporated by reference.

### BACKGROUND OF THE INVENTION

The invention concerns a method for moistening or wetting bulk material in a mixing container which operates in batches or continuously, with one or several fluids or pastes.

A method of this type is known from DE 39 13 384 A1.

The production of e.g. scouring, cleaning or cleansing agents often involves mixing processes wherein liquid components have to be applied to dry carrier substances. It is known to supply the liquid via nozzles or filler necks, partially as vapour. To evenly distribute the liquid and prevent formation of agglomerates, often cutter heads are used in the mixers. The cutter heads may also disintegrate the carrier substances which would make them unsuitable for use with fragile carrier substances.

When the fluids are atomized, the cutter heads may be omitted. If the carrier substances are to be coated with viscous or paste-like substances, atomization of such pastes is difficult since the nozzles tend to block easily. Pastes moreover often form agglomerates.

To be able to further process and/or recycle produced bulk material, it must usually be transported. Transport may become necessary already within the productional course in factories, e.g. through assembly lines or conveyor worms or later through transport in containers and/or on lorry loading areas.

During loading and transport of the bulk material, the tendency of the bulk particles to develop dust results in the surfaces of the devices, machines, objects etc. located close to the loading location, being covered with bulk material dust.

The tendency to produce dust can be counteracted through additional moistening through spraying with a liquid medium as disclosed e.g. in the method known from DE 39 13 384 A1.

To moisten the individual bulk material particles, the mixing device according to the teachings of DE 39 13 384 A1 comprises an additional nozzle for spraying the bulk material particles. Dust may thereby get stuck on the nozzle and block same and dust may adhere to the mixer wall.

It is the object of the present invention to develop an improved method for uniform moistening or wetting of bulk material with fluids or pastes.

### SUMMARY OF THE INVENTION

In accordance with the invention, this object is achieved in that the fluids or pastes are cooled below their solidification point before being introduced into the mixing container and being mixed with the bulk material contained in the mixing container and that the solid fluids or pastes are re-fluidized in the mixer during the mixing process or after termination of a mixing process.

This method allows optimum mixture of fluids or pastes with bulk material to produce uniform distribution of the fluids or pastes in the bulk material. The precondition thereof is that a component is created which can be rapidly and uniformly mixed under mechanical strain. This is achieved in that the aggregate state of the fluids or pastes is changed. In solid form, the pastes and fluids can be very easily mixed with bulk material into a homogeneous bulk material mixture. The desired mixing quality can be achieved within short mixing times and minimum mechanical strain of the mixing material to be processed.

The method is particularly suited for a uniform distribution of fluids or pastes of high viscosity and surface tension such as e.g. oils, lecithines, resins, gums, gels, fats, waxes, latices, polymer solutions and adhesives in microdispersed or fragile as well as two-dimensional bulk material, since agglomerates are not formed due to mixing of the bulk material with frozen pastes or fluids. The bulk material may have i.a. hydrophobic, lipophobic or hygroscopic properties.

A further advantage of the uniform and rapid distribution of the solidified pastes or fluids in a highly-fragile or microdispersed solid system (bulk material) consists in that when the fluids or pastes a re-fluidized, the bulk material is uniformly moistened or wetted.

The time of re-liquidization can be delayed in that the fluids or pastes are cooled far below their solidification point. This method is also called cryo-wetting.

Destruction of the bulk material is prevented in that mixing of the solidified fluids or pastes with the bulk material requires only short mixing times.

Addition of the pastes or fluids cooled down below their solidification point into the mixing container may be carried out simultaneously with the bulk material to be treated or after filling in the bulk material which is to be treated with the cooled-down paste or the solidified fluid. The temporal sequence of filling in the bulk material and solidified pastes or fluids is not important for the present invention.

A preferred variant of the inventive method is characterized in that the fluids or pastes are cooled down slowly below their solidification point, thereby producing crystalline solids with large crystals.

In a further variant of the inventive method, the fluids or pastes are shock-frozen. Rapid solidification of the fluids or pastes produces very small crystals or largely prevents formation of crystals such that amorphous solids are produced instead of crystalline solids.

In a particularly preferred further development of the inventive method, the fluids or pastes are cooled below their solidification point by superfine spraying into a freezing chamber. Through this approach, very small solid particles are produced which can be mixed particularly easily and rapidly with the bulk material. The particles can furthermore be re-fluidized with only little energy due to the small volume. Usually, even the mixing temperature or heat content of the bulk material to be wetted will be sufficient for re-liquidization.

A further preferred method variant is characterized in that the solidified fluids or pastes are micronized. This means that the solidified fluids and pastes are disintegrated with methods and devices known per se. Disintegration is required to achieve uniform moistening or wetting. If only large pieces of solidified fluids or pastes were introduced into the bulk material, re-liquidization would in points effect excessive moistening whereas moistening at other locations would not be sufficient. Strong moisturization in points could lead to formation of an agglomerate.

Micronization of the solidified fluids or pastes has furthermore the advantage that the added solidified fluids or pastes can be exactly metered. In particular, very small amounts of the micronized fluids or pastes can be added to the bulk material.

It is advantageous if the solidified fluids or pastes are ground. The size of the particles to be mixed with the bulk material or the grain spectrum can be predetermined. The smaller the particles, the quicker re-liquidization occurs. The moment of re-liquidization can be chosen and its duration be predetermined through suitable selection of the particle size. Re-fluidization should generally be carried out only when sufficient mixing of the solidified pastes or fluids with the bulk material has taken place. With certain bulk material it may also be desirable to effect adsorption of the re-fluidized fluids or pastes in that the bulk material particles receive during mixing the re-fluidized fluid or paste from the surface of the particles where re-fluidization starts. In this case, larger particles would be advantageous since they would delay re-liquidization.

A particularly preferred further development of the method is characterized in that re-liquidization of the solidified fluids or pastes is effected or accelerated through external energy supply. The external energy supply may occur e.g. either through contact, convection, radiation or microwave heating.

It is furthermore feasible to effect heating of the bulk material through the mixing tools.

The invention concerns a method for moistening or wetting of bulk material. The fluids or pastes are thereby cooled down to their solidification point before being mixed with the bulk material to be wetted. During mixing or after mixing with the bulk material, moistening or wetting is carried out through re-liquidization of the solidified fluids or pastes. This method permits uniform and agglomerate-free moistening or wetting of bulk material.

I claim:

1. Method for moistening or wetting of bulk material in a mixing container which operates in batches or continuously, with one or more fluids or pastes, wherein the fluids or pastes are cooled down below their solidification point before being introduced into the mixing container and being mixed with the bulk material contained in the mixing container and wherein the solid fluids or pastes are re-liquidized in the mixer during the mixing process or after termination of the mixing process.

2. Method according to claim 1, wherein the fluids or pastes are slowly cooled down below their solidification point.

3. Method according to claim 1, wherein the fluids or pastes are shock-frozen.

4. Method according to claim 1, wherein the fluids or pastes are cooled down below their solidification point through superfine spraying into a freezing chamber.

5. Method according to claim 1, wherein the solidified fluids or pastes are micronized.

6. Method according to claim 1, wherein the solidified fluids or pastes are ground.

7. Method according to claim 1, characterized in that the re-liquidization of the solidified fluids or pastes is carried out or accelerated through external energy supply.
